(19) United States
(12) Patent Application Publication
(10) Pub. No.: US 2024/0383752 A1
(43) Pub. Date: Nov. 21, 2024

(54) REACTIVE DISTILLATION PROCESS FOR PREPARING FLUOROSULFONYLIMIDE SALTS

(71) Applicant: SPECIALTY OPERATIONS FRANCE, Lyon (FR)

(72) Inventor: Denis Revelant, Genas (FR)

(73) Assignee: SPECIALTY OPERATIONS FRANCE, Lyon (FR)

(21) Appl. No.: 18/687,245

(22) PCT Filed: Aug. 23, 2022
(86) PCT No.: PCT/EP2022/073429

§ 371 Date: Feb. 27, 2024

(30) Foreign Application Priority Data
Aug. 27, 2021 (EP) 21315147.5
Oct. 8, 2021 (EP) 21201565.5

(51) Int. Cl. C01B 21/086; B01D 3/00; B01D 3/36; C01B 21/093

(52) U.S. Cl. CPC C01B 21/086; B01D 3/009; B01D 3/36; C01B 21/093; C01P 2006/40

(57) ABSTRACT

The present invention relates to a process for preparing a fluorosulfony limide salt. More specifically. the present invention relates to a process for preparing lithium bis(fluorosulfonyl)imide (LiFSI).

### CROSS-REFERENCE TO RELATED PATENT APPLICATIONS

The present invention claims priorities filed on 27 Aug. 2021 in EUROPE with Nr. 21315147.5 and on Oct. 8, 2021 in EUROPE with Nr. 21201565.5.the whole content of these application being incorporated herein by reference for all purposes.

### FIELD OF THE INVENTION

The present invention relates to a process for preparing a fluorosulfonylimide salt. More specifically. the present invention relates to a process for preparing lithium bis (fluorosulfonyl) imide (LiFSI).

### TECHNICAL BACKGROUND

Fluorosulfonylimide salts are useful compounds in a wide variety of fields. and are used as electrolytes, as additives added to the electrolytes of fuel cells. and as selective electron withdrawing materials and the like (see for example Published Japanese Translation No. Hei 08-511274 of PCT). Fluorosulfonylimide alkali metal salts and various fluorosulfonylimide onium salts can be obtained by cation exchange reactions using an alkali metal compound or an onium compound. Fluorosulfonylimide ammonium salts are useful as production intermediates for fluorosulfonylimide alkali metal salts and fluorosulfonylimide onium salts other than ammonium salts.

Various methods have been proposed for synthesizing fluorosulfonylimide ammonium salts.

For example, Zeitschrift fuer Chemie (1987-27 (6). pages 227 to 228) discloses a method of synthesizing a di (fluorosulfonyl) imide ammonium salt from di (fluorosulfonyl) imide and ammonia.

JP 2010-168308 (Nippon Shokubai Co., Ltd.) discloses a method of synthesizing a bis [di(fluorosulfonyl)imide] onium salt by reacting di(chlorosulfonyl) imide with an onium compound to obtain a chlorosulfonylimide onium salt, and then reacting this onium salt with a fluoride containing at least one element selected from the group consisting of elements of group 11 to group 15 and elements in the fourth to sixth periods (but excluding arsenic and antimony). Examples disclosed for the fluoride used in the production process described in JP 2010-168308 include zinc fluoride (ZnF₂). copper fluoride (CuF₂) and bismuth fluoride (BiF₂). These compounds are all solid substances at normal temperature.

Further. John K. Ruff and Max Lustig, Inorg. Synth., 11, 138 to 140(1968) and Jean'ne M. Shreeve et al., Inorg. Chem., 1998, 37 (24), 6295 to 6303 disclose a method of directly synthesizing di (fluorosulfonyl) imides from di (chlorosulfonyl) imides using arsenic trifluoride (AsF3) or antimony trifluoride (SbF3) as a fluorinating agent.

CN 109734061 (HUNAN FUBANG NEW MAT CO., LTD.) discloses a process for manufacturing lithium difluorosulfonyl imide, which includes the following operation steps:
acquiring the difluorosulfonyl imide:
mixing and reacting the difluorosulfonyl imide and an alkaline lithium source in a non-aqueous solvent which can form an azeotrope with water, wherein the non-aqueous solvent comprises one or more of pyridine and chloroethanol, and a crude product solution of the difluorosulfonyl imide lithium is obtained by filtration, and the alkaline lithium source comprises one or more of LiOH, LiHCO3 and Li2CO3:
drying the crude product solution of lithium di (fluorosulfonyl) imide under reduced pressure in an environment with a vacuum degree of 1,000-100 Pa and a temperature of 30-80° C.: and
when the product is pasty, reducing the vacuum degree to below 10-2 Pa and drying to obtain the crude product of lithium difluorosulfonyl imide.

LiFSI (lithium bis (fluorosulfonyl) imide) is known to be sensitive to water and can react to form unwanted species like FSO3Li and/or FSO2NH2, which severely degrade the quality and the electrochemical properties of the LiFSI product.

EP 3170789 (Nippon Soda Co., Ltd.) discloses a process for producing fluorosulfonylimide salts. However, the fluorosulfonyl salts are not protected from water being present in the reaction solution during the cation exchange reaction.

EP 2662332 (Nippon Soda Co., Ltd.) discloses a process for producing a metal or onium salt of bis (fluoro sulfonyl) imide comprising subjecting an ammonium salt of bis (fluoro sulfonyl) imide to a cation exchange reaction under reduced pressure, using at least one compound selected from the group consisting of metal hydroxide and onium hydroxides. Under this reaction, ammonia is generated as a by-product in the cation exchange reaction, which is removed by performing the reaction under reduced pressure.

EP 2977349 (Nippon Soda Co., Ltd.) discloses a method for producing a disulfonlamine akali metal salt, including:
a step of subjecting a disulfonylamine onium salt to a cation exchange reaction in an organic solvent, thereby producing a disulfonylamine alkali metal salt, and
a step of filtering the organic solvent solution containing the disulfonylamine alkali metal salt through a filter having a particle retention size of 0.1 to 10 μm to otain a filtrate.

According to the examples, first ammonium di (fluorosulfonyl) amine is reacted with lithium hydroxide monohydrate under reflux in a suitable organic solvent, then the organic phase and the water phase are separeted and the organic phases further treated under reduced pressure to remove moisture from the solution. Filtration is then performed followed by solvent evaporation. Hence, according to such description, the removal of water is not performed simoultaneously to the cation exchange reaction.

WO 2021/074142 (Solvay SA) dislcoses a method for producing a salt of bis (fluorosulfonyl) imide that comprises a step of crystallizing a raw salt of bis (sulfonyl imide) within a crystallization solvent comprising at least a halogenated alcohol. This document dislcoses in Example 3 a process comprising solubilizing 33 g of NH₄FSI crystal in 300 g of ethyl methyl carbonate and then adding 76 g of a 23 wt. % aqueous solution of LiOH.H₂O. The organic phase was then recovered and concentrated by rotary evaporator at 20° C. under reduced pressure (3 mbar). Hence, according to such description, the removal of water proceeds after the cation exchange reaction.

### SUMMARY OF THE INVENTION

It is an object of the present invention to provide an efficient process for preparing a fluorosulfonylimide salt, wherein the degradation of the salt and the degradation of the electrochemical properties are suppressed. Specifically, it is an object of the present invention to provide an efficient process for preparing lithium bis (fluorosulfonyl) imide (LiFSI), wherein the degradation of the salt and the degradation of the electrochemical properties are suppressed.

It has now been found that these and other objects can be solved by the process according to the present invention.

The present invention relates to a process for preparing a fluorosulfonylimide salt represented by the following formula (I):

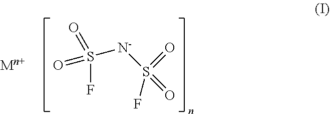

wherein Mⁿ⁺ represents a metal cation or an onium cation, wherein the onium cation is not an ammonium cation, and n corresponds to the valency of the metal cation or the onium cation and is an integer of from 1 to 4:

comprising the following steps:
ii) reacting ammonium bis (fluorosulfonyl) imide (NH4FSI), preferably in a form of a solvate with at least one solvent S₂, with a compound (C) selected from the group consisting of a metal compound, an onium compound and an organic amine compound in at least one solvent S₃; and
iii) removing at least a part of any water being present in the reaction solution from the reaction solution; wherein the steps ii) and iii) are carried out simultaneously.

The present invention is based on the recognition that by removing water being present in the reaction solution from the reaction solution the moisture induced degradation of fluorosulfonylimide salts and the moisture induced degradation of the electrochemical properties of fluorosulfonylimide salts is efficiently suppressed. Furthermore, the yield of the process for synthesizing fluorosulfonylimide salts can be increased by removing water being present in the reaction solution from the reaction solution.

### DRAWINGS

FIG. 1 is a representation of the scheme of the process as disclosed in the Example.

### DETAILED DESCRIPTION OF THE INVENTION

According to the present invention the term “about” means ±10% of the specified numeric value, preferably ±5%, more preferably ±2% and even more preferably ±1%.

The present invention relates to a process for preparing a fluorosulfonylimide salt represented by the following formula (I):

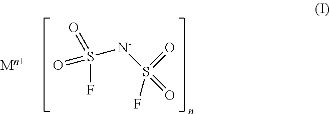

wherein Mⁿ⁺ represents a metal cation or an onium cation, wherein the onium cation is not an ammonium cation (NH₄⁺), and n corresponds to the valency of the metal cation or the onium cation and is an integer of from 1 to 4: comprising the following steps:
ii) reacting ammonium bis (fluorosulfonyl) imide (NH4FSI), preferably in a form of a solvate with at least one solvent S₂, with a compound (C) selected from the group consisting of a metal compound, an onium compound and an organic amine compound in at least one solvent S₃; and
iii) removing at least a part of any water being present in the reaction solution from the reaction solution: wherein the steps ii) and iii) are carried out simultaneously.

Although there are no particular limitations on the metal cation, an alkali metal cation is preferable. Examples of the alkali metal cation include a lithium cation, sodium cation, potassium cation, rubidium cation and cesium cation. Of these, a lithium cation, sodium cation or potassium cation is preferable, and most preferable is a lithium cation.

Examples of the onium cation, wherein the onium cation is not an ammonium cation (NH₄⁺), include a phosphonium cation, oxonium cation, sulfonium cation, fluoronium cation, chloronium cation, bromonium cation, iodonium cation, selenonium cation, telluronium cation, arsonium cation, stibonium cation, bismutonium cation; iminium cation, diazenium cation, nitronium cation, diazonium cation, nitrosonium cation, hydrazonium cation, diazenium dication, diazonium dication, imidazolium cation, pyridinium cation, quaternary ammonium cation, tertiary ammonium cation, secondary ammonium cation, primary ammonium cation, piperidinium cation, pyrrolidinium cation. morpholinium cation, pyrazolium cation, guanidinium cation, isouronium cation and isothiouronium cation.

The onium cation is preferably an onium cation having an organic group, namely an organic onium cation. Examples of the organic group include saturated and unsaturated hydrocarbon groups. The saturated or unsaturated hydrocarbon group may be linear, branched or cyclic. The number of carbon atoms that constitute the saturated or unsaturated hydrocarbon group is preferably from 1 to 18, and more preferably from 1 to 8. The atoms or atom groupings that constitute the organic group preferably include a hydrogen atom, fluorine atom, amino group, imino group, amide group, ether group, hydroxyl group, ester group, carboxyl group, carbamoyl group, cyano group, sulfone group, sulfide group, nitrogen atom, oxygen atom or sulfur atom; and more preferably include a hydrogen atom, fluorine atom, ether group, hydroxyl group, cyano group or sulfone group. The organic group may have only one of these atoms or atom groupings, or may have two or more of the atoms or atom groupings. When two or more organic groups are bonded, bonds may be formed between the main structures of the organic groups, between the main structures of the organic groups and an aforementioned atom grouping, or between atom groupings described above.

Examples of the onium cation having an organic group include imidazolium cations such as a 1,3-dimethylimidazolium cation, 1-ethyl-3-methylimidazolium cation, 1-propyl-3-methylimidazolium cation, 1-butyl-3-methylimidazolium cation, 1-pentyl-3-methylimidazolium cation, 1-hexyl-3-methylimidazolium cation, 1-heptyl-3-methylimidazolium cation, 1-octyl-3-methylimidazolium cation, 1-decyl-3-methylimidazolium cation, 1-tetradecyl-3-methylimidazolium cation, 1-hexadecyl-3-methylimidazolium cation, 1-octadecyl-3-methylimidazolium cation, 1-allyl-3-ethylimidazolium cation, 1-allyl-3-butylimidazolium cation, 1,3-diallylimidazolium cation, 1-ethyl-2,3-dimethylimidazolium cation, 1-butyl-2,3-dimethylimidazolium cation, 1-hexyl-2,3-methylimidazolium cation, and 1-hexadecyl-2,3-methylimidazolium cation: pyridinium cations such as a 1-ethylpyridinium cation, 1-butylpyridinium cation,

1-hexylpyridinium cation, 1-octylpyridinium cation, 1-ethyl-3-methylpyridinium cation, 1-ethyl-3-hydroxymethylpyridinium cation, 1-butyl-3-methylpyridinium cation, 1-butyl-4-methylpyridinium cation, 1-octyl-4-methylpyridinium cation, 1-butyl-3,4-dimethylpyridinium cation, and 1-butyl-3,5-dimethylpyridinium cation:
quaternary ammonium cations such as a tetramethylammonium cation, tetraethylammonium cation, tetrapropylammonium cation, tetrabutylammonium cation, tetraheptylammonium cation, tetrahexylammonium cation, tetraoctylammonium cation, triethylmethylammonium cation, propyltrimethylammonium cation, diethyl-2-methoxyethylmethylammonium cation, methyltrioctylammonium cation, cyclohexyltrimethylammonium cation, 2-hydroxyethyltrimethylammonium cation, trimethylphenylammonium cation,

benzyltrimethylammonium cation, benzyltributylammonium cation, benzyltriethylammonium cation, dimethyldistearylammonium cation, diallyldimethylammonium cation, 2-methoxyethoxymethyltrimethylammonium cation, and tetrakis (pentafluoroethyl) ammonium cation;
tertiary ammonium cations such as a trimethylammonium cation, triethylammonium cation, tributylammonium cation, diethylmethylammonium cation, dimethylethylammonium cation, dibutylmethylammonium cation, and 4-aza-1-azoniabicyclo[2.2.2]octane cation; secondary ammonium cations such as a dimethylammonium cation, diethylammonium cation, and dibutylammonium cation:

primary ammonium cations such as a methylammonium cation, ethylammonium cation, butylammonium cation, hexylammonium cation, and octylammonium cation;
organic ammonium cations such as an N-methoxytrimethylammonium cation, N-ethoxytrimethylammonium cation, and N-propoxytrimethylammonium cation: piperidinium cations such as a 1-propyl-1-methylpiperidinium cation and 1-(2-methoxyethyl)-1-methylpiperidinium cation:
pyrrolidinium cations such as a 1-propyl-1-methylpyrrolidinium cation, 1-butyl-1-methylpyrrolidinium cation, 1-hexyl-1-methylpyrrolidinium cation, and l-octyl-1-methylpyrrolidinium cation:
morpholinium cations such as a 4-propyl-4-methylmorpholinium cation and 4-(2-methoxyethyl)-4-methylmorpholinium cation: pyrazolium cations such as a 2-ethyl-1,3,5-trimethylpyrazolium cation, 2-propyl-1,3,5-trimethylpyrazolium cation, 2-butyl-1,3,5-trimethylpyrazolium cation, and 2-hexyl-1,3,5-trimethylpyrazolium cation;
guanidinium cations such as a guanidinium cation and a 2-ethyl-1,1,3,3-tetramethylguanidinium cation:
sulfonium cations such as a trimethylsulfonium cation: phosphonium cations such as a trihexyltetradecylphosphonium cation: isouronium cations such as a 2-ethyl-1,1,3,3-tetramethylisouronium cation: and isothiouronium cations such as a 2-ethyl-1,1,3,3-tetramethylisothiouronium cation.

Among these, the onium cation preferably contains no metal elements that degrade electrolyte properties and the like. Specifically, imidazolium cations such as a 1,3-dimethylimidazolium cation, 1-ethyl-3-methylimidazolium cation, 1-butyl-3-methylimidazolium cation, 1-hexyl-3-methylimidazolium cation, 1-octyl-3-methylimidazolium cation, 1-allyl-3-ethylimidazolium cation, 1-allyl-3-butylimidazolium cation, 1,3-diallylimidazolium cation, 1-ethyl-2,3-dimethylimidazolium cation, 1-butyl-2,3-dimethylimidazolium cation, and 1-hexyl-2,3-dimethylimidazolium cation: and organic ammonium cations such as a propyltrimethylammonium cation, diethyl-2-methoxyethylmethylammonium cation, methyltrioctylammonium cation, cyclohexyltrimethylammonium cation, 2-hydroxyethyltrimethylammonium cation, trimethylammonium cation, triethylammonium cation, tributylammonium cation, and 4-aza-1-azoniabicyclo [2.2.2]octane cation are preferable.

According to the present invention, most preferably the fluorosulfonylimide salt represented by the following formula (I) is LiFSI.

According to the present invention, the process for preparing a compound according to formula (I) includes a step ii) of reacting NH₄FSI (ammonium bis (fluorosulfonyl) imide) with a compound (C) selected from the group consisting of a metal compound, an onium compound and an organic amine compound in a solvent. Hereinafter this reaction is also referred to as the cation exchange reaction.

According to a preferred embodiment, the NH₄FSI salt is a solvate, preferably in a crystallized form.

Preferably, said solvate comprises:
50 to 99 wt. %, of the NH₄FSI salt, and
1 to 50 wt. %, of solvent S2.

Preferably, said solvent S₂ is selected from the group consisting of cyclic and acyclic ethers.

Preferably, the NH₄FSI solvate comprises from 51 to 98 wt. %, more preferably from 55 to 95 wt. %, or from 78 to 83 wt. % of the NH₄FSI salt.

Preferably, the NH₄FSI solvate comprises from 2 to 49 wt. %, more preferably from 5 to 45 wt. % or from 17 to 22 wt. % of solvent S₂ as defined above.

When the NH₄FSI is in the form of solvate as above defined, the process comprises before step ii), a step i) of preparing a NH₄FSI solvate comprising the following steps:
i1) providing a crude salt of NH₄FSI:
i2) dissolving the crude salt of NH₄FSI in at least one solvent S₁:
i3) crystallizing the crude salt of NH₄FSI by means of at least one solvent S2; and
i₄) separating the NH₄FSI salt from at least part of the solvents S₁ and S₂, preferably by filtration.

The crude salt of NH₄FSI preferably comprises 80 to 97 wt. % of the salt of NH₄FSI, preferably 85-95 wt. %, more preferably 90-95 wt. %.

The solvent S₁ is preferably selected from the group consisting of acetonitrile, valeronitrile, adiponitrile, benzonitrile, methanol, ethanol, 1-propanol, 2-propanol, 2,2,2,-trifluoroethanol, n-butyl acetate, isopropyl acetate, and mixtures thereof: preferably 2,2,2,-trifluoroethanol.

The solvent S₂ is preferably selected from the group consisting of diethylether, diisopropylether, methyl-t-butylether, dimethoxymethane, 1,2-dimethoxyethane, tetrahydrofuran, 2-methyltetrahydrofuran, dioxolane, 1,3-dioxane, 4-methyl-1,3-dioxane, and 1,4-dioxane, and mixtures thereof. More preferably, the solvent S2 is selected from the group consisting of: diethyl ether, diisopropyl ether, methyl t-butyl ether, 1,2-dimethoxyethane, tetrahydrofuran, 2-methyltetrahydrofuran, dioxane and mixtures thereof. Even more preferably. solvent S2 is 1,3-dioxane or 1,4-dioxane.

Preferably, step i4) consists in separating the NH₄FSI salt from:
more than 99.9 wt. % of the solvent S₁: and
50 to 99 wt. % of the solvent S₂.

According to the present invention. the cation exchange reaction preferably is performed by mixing. in the presence of a solvent. NH₄FSI and a compound selected from the group consisting of a metal compound. an onium compound and an organic amine compound. wherein the compound preferably is a metal compound. more preferably an alkali metal compound. even more preferably a lithium compound. still more preferably LiOHxH₂O or Li₂CO₃ and most preferably LiOHxH₂O.

There are no particular limitations on the metal compounds used in the cation exchange reaction. provided it undergoes a cation exchange reaction with NH₄FSI.

Preferably. the metal compound is an alkali metal compound. More preferably. the metal compound is an alkali metal compound selected from the group consisting of LiOH, NaOH, KOH, RbOH, CSOH, LiOHxH₂O, NaOHxH₂O, KOHxH₂O, RbOHxH₂O, CsOHxH₂O, Li₂CO₃, Na₂CO₃, K₂CO₃, Rb₂CO₃, Cs₂CO₃, LiHCO₃, NaHCO₃, K₂CO₃, RbHCO₃ and CsHCO₃, even more preferably the metal compound is an alkali metal compound selected from the group consisting of LiOHxH₂O, NaOHxH₂O, KOHxH₂O, RbOHxH₂O, CsOHxH₂O, LizCO₃, Na₂CO₃, K2CO₃, Rb₂CO; and Cs₂CO₃, still more preferably the metal compound is an alkali metal compound selected from the group consisting of LiOHxH₂O and Li₂CO₃, and most preferably the metal compound is LiOHxH₂O.

In case an alkali metal compound is used. the amount of the used alkali metal compound preferably is of from about 1 mol to about 10 mol, more preferably of from about 1 mol to about 5 mol, even more preferably of from about 1 mol to about 2 mol, still more preferably of from about 1 mol to about 1.5 mol and most preferably about 1.1 mol, per 1 mol of NH₄FSI.

Examples of the onium compound used in the cation exchange reaction include nitrogen-based onium compounds such as imidazolium compounds, pyrazolium compounds, pyridinium compounds, pyrrolidinium compounds, piperidinium compounds, morpholinium compounds and quaternary ammonium compounds, phosphorus-based onium compounds such as quaternary phosphonium compounds and tertiary phosphine compounds, sulfur-based onium compounds such as sulfonium compounds, as well as guanidinium compounds, isouronium compounds and isothiouronium compounds. Among these compounds, organic onium compounds are preferable. Further, the onium compound preferably contains no metal elements that degrade electrolyte properties and the like.

Preferably, the onium compound is a hydroxide compound.

Specific examples of the imidazolium compounds include hydroxides such as 1,3-dimethylimidazolium hydroxide, 1-ethyl-3-methylimidazolium hydroxide, 1-butyl-3-methylimidazolium hydroxide, 1-hexyl-3-methylimidazolium hydroxide, 1-octyl-3-methylimidazolium hydroxide, 1-allyl-3-ethylimidazolium hydroxide, 1-allyl-3-butylimidazolium hydroxide, 1,3-diallylimidazolium hydroxide, 1-ethyl-2,3-dimethylimidazolium hydroxide, 1-butyl-2,3-dimethylimidazolium hydroxide and 1-hexyl-2,3-dimethylimidazolium hydroxide.

Specific examples of the pyrazolium compounds include hydroxides such as 2-ethyl-1,3,5-trimethylpyrazolium hydroxide, 2-propyl-1,3,5-trimethylpyrazolium hydroxide, 2-butyl-1,3,5-trimethylpyrazolium hydroxide and 2-hexyl-1,3,5-trimethylpyrazolium hydroxide.

Specific examples of the morpholinium compounds include 4-propyl-4-methylmorpholinium hydroxide, and 4-(2-methoxyethyl)-4-methylmorpholinium hydroxide.

Specific examples of the quaternary ammonium compounds include hydroxides such as propyltrimethylammonium hydroxide, diethyl-2-methoxyethylmethylammonium hydroxide, methyltrioctylammonium hydroxide, cyclohexyltrimethylammonium hydroxide and 2-hydroxyethyltrimethylammonium hydroxide.

Specific examples of the guanidinium compounds include guanidinium hydroxide, and 2-ethyl-1, 1,3,3-tetramethylguanidinium hydroxide.

A specific example of an isouronium compound is 2-ethyl-1,1,3,3-tetramethylisouronium hydroxide.

A specific example of an isothiouronium compound is 2-ethyl-1,1,3,3-tetramethylisothiouronium hydroxide.

In case an onium compound is used, the amount of the used onium compound is of from about 1 mol to about 10 mol, more preferably of from about 1 mol to about 5 mol, even more preferably of from about 1 mol to about 2mol, still more preferably of from about I mol to about 1.5 mol and most preferably about 1.1 mol, per 1 mol of NH₄FSI.

Examples of the organic amine compound used in the cation exchange reaction include tertiary amines such as trimethylamine, triethylamine and tributylamine, cyclic amines such as 1,4-diazabicyclo [2.2.2] octane, tertiary amine salts such as trimethylamine hydrochloride, triethylamine hydrochloride, tributylamine hydrochloride, 1,4-diazabicyclo [2.2.2] octane hydrochloride, trimethylamine hydrobromide, triethylamine hydrobromide and tributylamine hydrobromide, and cyclic amine salts such as 1,4-diazabicyclo [2.2.2] octane hydrobromide.

Among these compounds, tertiary amines and cyclic amines are preferable.

In case an organic amine compound is used, the amount of the used organic amine compound is of from about 1 mol to about 10 mol, more preferably of from about 1 mol to about 5 mol, even more preferably of from about 1 mol to about 2 mol, still more preferably of from about 1 mol to about 1.5mol and most preferably about 1.1 mol, per 1 mol of NH₄FSI.

Preferably, the metal compound is LiOHxH₂O or Li₂CO₃, and the amount of the used metal compound is about 1.1 mol, per 1 mol NH₄FSI, more preferably the metal compound is LiOHxH₂O and the amount of the used metal compound is about 1.1 mol, per 1 mol NH₄FSI.

There are no particular limitations on the temperature during the cation exchange reaction, but preferably in step ii) the reaction temperature is of from about 0° C. to about 100° C., more preferably of from about 5° C. to about 70° C. even more preferably of from about 10° C. to about 50° C. and most preferably about 15° C.

There are no particular limitations on the reaction pressure during the cation exchange reaction, but preferably in step ii) the reaction pressure is of from atmospheric pressure to about 0.01 mbar, more preferably of from about 800 mbar to about 0). 1 mbar, even more preferably of from about 600 mbar to about 1 mbar, still more preferably of from about 400 mbar to about 10 mbar, still even more preferably of from about 200 mbar to about 15 mbar, and most preferably about 30 mbar.

There are no particular limitations on the organic solvent S3 used in the cation exchange reaction. Examples of preferred solvents include aprotic solvents such as ethylene carbonate, propylene carbonate, butylene carbonate, γ-butyrolactone, γ-valerolactone, dimethoxymethane, 1,2-dimethoxyethane, tetrahydrofuran, 2-methyltetrahydrofuran, 1,3-dioxane, 4-methyl-1,3-dioxolane, methyl formate, methyl acetate, methyl propionate, dimethyl carbonate, ethyl methyl carbonate, diethyl carbonate, sulfolane, 3-methylsulfolane, dimethylsulfoxide, N,N-dimethylformamide, N-methyl oxazolidinone, acetonitrile, valeronitrile, benzonitrile, ethyl acetate, isopropyl acetate, n-butyl acetate, nitromethane and nitrobenzene. More preferred solvents include ethylene carbonate, propylene carbonate, butylene carbonate, tetrahydrofuran, dimethyl carbonate, ethyl methyl carbonate, diethyl carbonate, ethyl acetate, isopropyl acetate and n-butyl acetate, even more preferred solvents include dimethyl carbonate, ethyl methyl carbonate, diethyl carbonate, ethyl acetate, isopropyl acetate and n-butyl acetate, still more preferred solvents include ethyl methyl carbonate and n-butyl acetate, the most preferred solvent is ethyl methyl carbonate.

The reaction time required for the cation exchange reaction varies depending on the reaction scale, but is preferably of from about 1 hr to about 48hr, and more preferably of from about 1.5 hr to about 24 hr, even more preferably of from about 1.5 hr to about 12 hr, still more preferably of from about 2 hr to about 10 hr and most preferably of from about 3 hr to about 6 hr.

Preferably, the compound of step ii) is added to the ammonium bis (fluorosulfonyl) imide (NH₄FSI) over a time range of from about 0.5 hr to about 10 hr, more preferably of from about 1 hr to about 8 hr, even more preferably of from about 1 hr to about 6 hr, still more preferably of from about 1.5 hr to about 5 hr and most preferably of from about 2 hr to about 4 hr.

The reaction vessel may be made of a resin such as a fluororesin or a polyethylene resin, preferably a fluororesin.

The process according to the present invention comprises step iii) of removing at least a part of any water being present in the reaction solution from the reaction solution.

At least part of the solvent S₂ present in the NH₄FSI solvate may also be removed from the reaction solution during step iii).

Preferably, step iii) consists in removing, by distillation, preferably by azeotropic distillation:
at least a part of any water being present in the reaction solution from the reaction solution, preferably more than 99.0 wt. % of the water, and
at least a part of the solvent S₂ present in the NH₄FSI solvate, preferably more than 99.0 wt. % of the solvent S₂ present in the NH₄FSI solvate.

The water being present in the reaction solution may be formed during the reaction as a by-product or it may be introduced into the reaction solution by moist starting material. The removal of at least a part of any water being present in the reaction solution from the reaction solution may have two effects. On the one hand, the degradation of water sensitive fluorosulfonylimide salts according to formula (I) is suppressed and therefore also the degradation of the electrochemical properties of these salts is suppressed. On the other hand, if water is formed as a by-product during the cation exchange reaction, as shown in the following reaction scheme, by the removal of the water the equilibrium can be adjusted to a state that promotes the cation exchange reaction. Therefore, by the removal of at least a part of any water being present in the reaction solution from the reaction solution, both the yield of the process according to the present invention can be increased and the quality of the fluorosulfonylimide salt and its electrochemical properties can be improved.

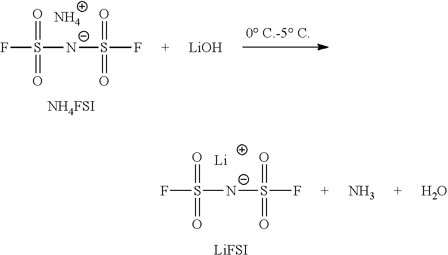

The at least part of any water being present in the reaction solution, and preferably at least part solvent S₂, may be removed from the reaction solution by any method known in the art such as drying agents or distillation methods.

Preferably, the at least a part of any water being present in the reaction solution, and preferablyat least part solvent S₂, is removed from the reaction solution by distillation, more preferably the at least a part of the water is removed by azeotropic distillation.

Preferably, the at least a part of any water being present in the reaction solution, and preferably at least part solvent S₂, is removed by azeotropic distillation, wherein in step ii) the reaction temperature is of from about 10° C. to about 50° C. and the reaction pressure is of from about 200 mbar to about 50mbar, more preferably the at least a part of any water being present in the reaction solution is removed by azeotropic distillation, wherein in step ii) the reaction temperature is about 15° C. and the reaction pressure is about 100 mbar.

Preferably, the process according to the present invention further comprises after step iii), the following step: iv) of adding more of the solvent S₃ to the reaction solution; wherein steps ii), iii) and iv) are carried out simultaneously.

In case the removal of the at least a part of any water being present in the reaction solution leads to a loss of solvent S₃ from the reaction solution, more additional solvent S₃ is added to the reaction solution, e.g. by a solvent dosing unit.

Preferably, in step iv) the solvent is added over time so that the molar concentration of the sulfonylimide salts in the reaction solution is kept substantially constant. In this regard, “substantially constant” means that the molar concentration of the sulfonylimide salts in the reaction solution do not change more than about 0.2 mol/l, preferably about 0.1 mol/l.

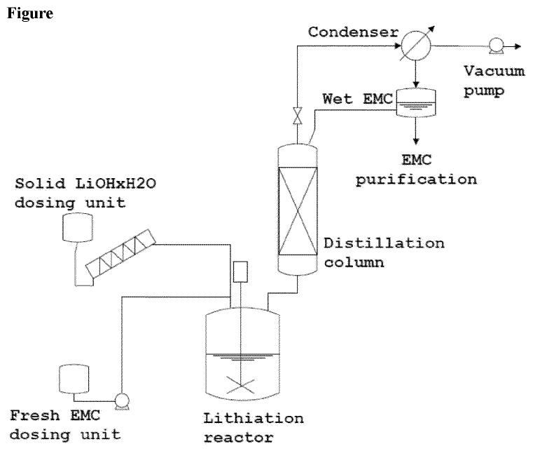

In general, the principal scheme of the process is shown in FIG. 1. Step ii) may be carried out in a steered reactor equipped with a distillation column using EMC (ethyl methyl carbonate) as a solvent and LiOHxH20 as a lithiation compound. Step iii) is accomplished via azeotropic distillation. A vacuum pump may be used to accomplish the azeotropic distillation. The wet solvent may be condensed in a condenser and separated from the reaction solution. Step iii) is accomplished by an EMC dosing unit and the lithiation compound is added via a solid dosing unit over time.

### EXAMPLE

The present invention is described below in further detail based on an example. However, the present invention is in no way limited by the following example, and appropriate changes can, of course, be made while still conforming with the purport of the present invention, and such changes are all deemed to be included within the technical scope of the present invention.

In a 500 ml steered tank reactor equipped with a distillation column, a condenser, a powder dosing unit and a solvent dosing unit (see FIG. 1), 3.75 mol (390 g) of EMC and 0.250 mol (49.5 g) of ammonium bis (fluorosulfonyl) imide (NH₄FSI) were loaded and steered at 15° C. 0.275 mol (11.5 g) of lithium hydroxide monohydrate (LiOHxH₂O) were added progressively to the reaction solution over a 3 hr time period via the solid dosing unit (see FIG. 1). While LiOHxH₂O was added, the reaction temperature was kept at 15° C., the reaction pressure was reduced to lower than 30 mbar, and

EMC and water were removed by azeotropic distillation. The removed EMC and water were condensed on the overhead of the column and fresh EMC was added to the reactor to compensate the removed wet EMC and to keep the molar concentration of the fluorosulfonylimid salts constant (see FIG. 1). After the 3 hr of LiOHxH₂O addition and one additional hour of reaction time, the conversion of NH₄FSI was complete and the yield of LiFSI was more than 95%.

1. A process for preparing a fluorosulfonylimide salt represented by the following formula (I): 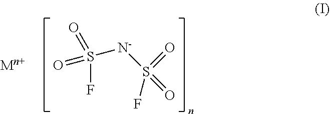
wherein Mⁿ⁺ represents a metal cation or an onium cation, wherein the onium cation is not an ammonium cation, and n corresponds to the valency of the metal cation or the onium cation and is an integer of from 1 to 4;
comprising the following steps:
ii) reacting ammonium bis (fluorosulfonyl) imide (NH₄FSI), with a compound (C) selected from the group consisting of a metal compound, an onium compound and an organic amine compound in at least one solvent S₃; and
iii) removing at least a part of any water being present in the reaction solution from the reaction solution;
wherein the steps ii) and iii) are carried out simultaneously.

2. The process according to claim 1, wherein the NH₄FSI is in the form of a solvate with at least one solvent S₂.

3. The process according to claim 2, wherein the NH₄FSI salt in the form of a solvate is:
in a crystallized form, and/or
comprises from 50 to 99 wt. %, of the NH₄FSI salt, and from 1 to 50 wt. %, of at least one solvent S₂.

4. The process according to claim 2, wherein said solvent S₂ is selected from the group consisting of cyclic and acyclic ethers.

5. The process according to claim 1, said process comprising before step ii), a step i) of preparing a NH₄FSI solvate comprising the following steps:
i₁) providing a crude salt of NH₄FSI;
i₂) dissolving the crude salt of NH₄FSI in at least one solvent S₁;
i₃) crystallizing the crude salt of NH₄FSI by means of at least one solvent S₂; and
i₄) separating the NH₄FSI salt from at least part of the solvents S₁ and S₂.

6. The process according to claim 1, wherein in step ii) the compound (C) is a lithium compound (C), selected from the group consisting of: lithium hydroxide LiOH, lithium hydroxide hydrate LiOH·H₂O, lithium carbonate Li₂CO₃, lithium hydrogen carbonate LiHCO₃, lithium chloride LiCl, lithium fluoride LiF, alkoxide compounds, alkyl lithium compounds, lithium acetate CH₃COOLi, and lithium oxalate Li₂C₂O₄.

7. The process according to claim 1, wherein, in step iii), the at least a part of any water being present in the reaction solution is removed from the reaction solution by distillation.

8. The process according to claim 1, wherein, in step iii), the solvent S₂ present in the NH₄FSI solvate is removed from the reaction solution by distillation.

9. The process according to claim 1, wherein in step iii) the reaction temperature is of from about 0° C. to about 100° C.

10. The process according to claim 1, wherein in step iii) the reaction pressure is of from atmospheric pressure to about 0.01 mbar.

11. The process according to claim 5, wherein the solvent S₁ is selected from the group consisting of acetonitrile, valeronitrile, adiponitrile, benzonitrile, methanol, ethanol, 1-propanol, 2-propanol, 2,2,2,-trifluoroethanol, n-butyl acetate, isopropyl acetate, and mixtures thereof.

12. The process according to claim 2, wherein the solvent S₂ is selected from the group consisting of diethylether, diisopropylether, methyl-t-butylether, dimethoxymethane, 1,2-dimethoxyethane, tetrahydrofuran, 2-methyltetrahydrofuran, dioxolane, 1,3-dioxane, 4-methyl-1,3-dioxane, and 1,4-dioxane, and mixtures thereof.

13. The process according to claim 1, wherein the solvent S₃ is ethyl methyl carbonate (EMC) or n-butyl acetate.

14. The process according to claim 1, wherein the compound (C) of step ii) is added to the ammonium bis (fluorosulfonyl) imide (NH₄FSI) over a time range of from about 0.5 hr to about 10 hr.

15. The process according to claim 1, wherein in formula (I): 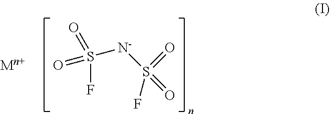
Mⁿ⁺ represents Li+, and
the process comprises the following steps:
i) preparing a NH₄FSI solvate by:
i₁) providing a crude salt of NH₄FSI;
1₂) dissolving the crude salt of NH₄FSI in at least one solvent S₁; i₃) crystallizing the crude salt of NH₄FSI by means of at least one solvent S₂; and i₄) separating the NH₄FSI salt from at least part of the solvents S₁ and S₂, to obtain a NH₄FSI solvate;
ii) reacting the NH₄FSI solvate from step i) with a lithium compound (C*) in at least one solvent S₃; and
iii) removing, by azeotropic distillation:
at least a part of any water being present in the reaction solution from the reaction solution more than 99.0 wt. % of the water, and
at least a part of the solvent S₂ present in the NH₄FSI solvate more than 99.0 wt. % of the solvent S₂,
wherein the steps ii) and iii) are carried out simultaneously.

16. The process according to claim 15, wherein:
step i₄) consists in separating the NH₄FSI salt from both more than 99.9 wt. % of the solvent S₁ and from 50 to 99 wt. % of the solvent S₂; and
said process comprises a step is) of drying the NH₄FSI solvate obtained in step i₄).
